(19) United States
(12) Patent Application Publication
(10) Pub. No.: US 2014/0345777 A1
(43) Pub. Date: Nov. 27, 2014

(54) METHOD OF MANUFACTURING A TIRE BEAD CORE ASSEMBLY, A TIRE BEAD CORE ASSEMBLY FORMING APPARATUS, A TIRE BEAD CORE ASSEMBLY, A TIRE, A BEAD FILLER INTERMEDIATE AND A USE OF A COMPRESSION MOULD

(71) Applicant: Robert Wilhelmus Franke, Losser (NL)

(72) Inventor: Robert Wilhelmus Franke, Losser (NL)

(73) Assignee: Robert Wilhelmus FRANKE, Losser (NL)

(21) Appl. No.: 14/344,647

(22) PCT Filed: Sep. 14, 2012
(86) PCT No.: PCT/NL2012/050649

§ 371 Date: Jul. 17, 2014

(30) Foreign Application Priority Data
Sep. 14, 2011 (NL) 2007414

(51) Int. Cl. B60C 15/06; B29C 43/18; B60C 15/04

(52) U.S. Cl. CPC B60C 15/0603; B60C 15/04; B29C 43/18; B29C 2043/189; B29L 2030/001
USPC 152/541; 264/263; 425/521

(57) ABSTRACT

The invention relates to a method of manufacturing a tire bead core assembly having a bead core and a bead filler. The method comprises the step of placing a bead core in the compression mould. The method also comprises the step of placing a bead filler intermediate in the compression mould. Further, the method comprises the step of pressing the bead filler intermediate onto the bead core using the compression mould. It is noted that the step of pressing the bead filler intermediate onto the bead core may comprise the step of transforming the bead filler intermediate into a bead filler.

The invention relates to a method of manufacturing a tire bead core assembly.

Among all sorts of elements composing a tire, there is a tire bead core assembly, which comprises a bead core, or so called bead wire core or bead, and a bead filler attached to the bead core. The bead filler, or so called filler, filler flange, filler strip, apex strip, or apex, generally has a triangular cross section configuration, while the bead core generally has a square or rectangular cross section configuration.

There are different known methods of manufacturing a tire bead core assembly.

American patent publication U.S. Pat. No. 5,632,836 discloses a first conventional method, wherein a ring shaped bead core is manufactured and temporarily mounted on a turntable, e.g. with use of movable mounting means. Subsequently, a substantially linear, elongated bead filler intermediate is provided, already having the triangular cross section configuration of the eventual bead filler, made by extrusion from an elastomeric filler material. The bead filler intermediate is fed straight to the temporarily mounted bead core, by means of a conveyor and/or rollers. With two frusto-conical rollers pressing against sloping side surfaces of the triangular intermediate a base surface of said triangular intermediate is pressed against an outer circumferential surface of the temporarily mounted bead core at such pressure that the base surface of the intermediate fuses with the peripheral surface of the core. The pair of press rollers is mounted in a fixed position relative to the turntable, such that upon rotation of the turntable the elongated bead filler intermediate is fed to and pressed against the peripheral surface of the bead core, until it forms a full circle around the core. The elongated bead filler intermediate is fed as a nearly continuous extrudate and is cut at the required length with the aid of a detector it is detected that a long enough piece of elongated intermediate has been fed to the bead core, whereupon the cut off trailing end of the intermediate is pressed onto the bead core and is connected to the opposite end of the intermediate.

In the method of U.S. Pat. No. 5,632,836 the intermediate is pressed against a peripheral outer surface of the bead core, with a base of the triangular shape of the intermediate, which means that upon rotation of the turntable during pressing of the intermediate, the base of the intermediate is fed over a smaller length than the tip of the triangular intermediate opposite the base, which will lead to deformation of the intermediate and especially to deformation of the opposing ends to be connected to each other.

American patent publication U.S. Pat. No. 6,089,294 discloses a second conventional method of manufacturing a tire bead core assembly, which largely corresponds with the above described first method of U.S. Pat. No. 5,632,836. In the method of U.S. Pat. No. 6,089,294 a preformed circular bead core is provided on a turntable. A linear bead filler intermediate having a circular cross section configuration is extruded and cut to a predetermined length, before feeding it to the bead core linearly. A proximal end of the pre-cut intermediate is put between a pair of positionally fixed pressing rollers. Subsequently the intermediate is attached to the ring shaped bead core by pressing it continuously onto an outer circumferential face of the rotating bead core, which is done with the aid of the pair of pressing rollers. Further, while the pressing rollers are attaching the intermediate onto the bead core, said pressing rollers are shaping the intermediate into a bead filler having a substantially rectangular configuration in cross section whose two corners on outer circumference of the bead fillers are rounded off. In this method the intermediate bead filler is pressed against an upper surface of the bead core.

Each of the above described known methods is cumbersome, time consuming and error-prone. For example, in both methods a plurality of actions needs to be executed at least partly simultaneously. Such partly simultaneously executed actions may for instance include among others: feeding the bead filler intermediate in a continuous movement to the bead core; rotating the bead core with respect to the fed, not yet attached bead filler intermediate; rotating the bead core with respect to the rollers; rotating the rollers in opposite directions with respect to the fed intermediate. Moreover, the bead intermediate will only be supported by the rollers and positioning relative to the bead core may be difficult, especially relatively to the turntable.

Besides, with both methods the end result will very much depend on the length of the intermediate. If it is cut off being too short, the proximal end of the intermediate will not touch its distal end, resulting in a defective bead core assembly. If, on the other hand, the intermediate is too long, it can be impossible to attach its distal end properly to the bead core, or the too long length may at least result in a local accumulation of filler material in the bead filler, which is highly undesirable. Moreover, as indicated the ends will be deformed due to the wrapping of the intermediate around the table.

Further, especially within the first method, but also within the second method, it is hard to align the proximal and distal end of the intermediate. After the proximal end is attached to the bead core, the ends of the intermediate may locally tilt with respect to the plane transverse to the axis of the bead core and/or to each other, and an axial location of a cutting surface located at the proximal end may shift to some extent. Therefore, said cutting surface may not fit tightly to a cutting surface at the lastly attached distal end of the bead filler intermediate.

Furthermore, the second known method may also result in accumulation of filler material due to the fact that the fitting rollers, during transforming the cross section configuration of the bead filler intermediate, may obstruct a part of the filler material of the intermediate conducted between said rollers. Therefore, the method is fallible and properly setting an apparatus for carrying out said method is cumbersome and time consuming.

German patent publication DE 10 2005 035 725 discloses a method for making ring shaped elements for tires using two preheated form profiles. The method comprises the steps of placing a bead core in one of the form profiles and extruding a rubber body to be vulcanized into the same, heated, form profile. Further, the method comprises the step of moving the first and second heated profile toward each other, thereby pressing the hot and then thus plastic rubber body into a shape defined by said profiles and connecting the ends of the heated rubber body simultaneously.

Besides, Japanese patent publication JP 63 154 334 discloses a further method for forming a bead core assembly. Here, a bead core is placed on a support surface. Then, a cylindrical rubber body is casted against an outer surface of the bead core by means of an extrusion machine. After cutting of the cylindrical rubber body, the rubber body is deformed by means of a top force pressed toward the support surface.

Japanese patent publication JP 60 157 840 discloses also a method wherein a plastic body is formed inside a mould. This is done in order to obtain a uniform bead filler. The plastic body is formed by injecting a string onto a lower profile of the mould while said lower profile is revolting multiple times.

Japanese patent publication JP 2006 159 719 discloses a method for making a bead core assembly. Also here a material for forming a bead filler is injection moulded into a mould.

The four methods mention above, in each of which a hot plastic body is injected into a mould, are cumbersome and error-prone. Besides, said methods are time consuming, for example because a plastic body needs to be created inside a mould in advance to pressing it onto a bead core. Moreover, heated moulds such as in the method of DE 10 2005 035 725, especially with two heated parts movable relative to each other, are relative complex, vulnerable and expensive.

Further, Japanese patent publication JP 2008 246 878 discloses a method for manufacturing a bead filler. A rubber body is injected in a continuous movement onto a rotating lower mould holding a bead core. While a further part of the continuously injected rubber body is injected onto the rotating lower mould, an earlier injected part of the rubber body is already deformed and pressed onto the bead core by means of an upper mould having a rotary shaft being at an angle with respect to a rotary shaft of the lower mould. Also this method is relatively cumbersome, error-prone and time consuming and uses relatively complex, vulnerably and expensive tools.

International patent publication WO 2010/134 475 also discloses a method for making a bead core assembly. In said method an annular bead core is supported by a first support structure. Then, a first continuous ribbon-shaped rubber material is laminated from a partly upward and partly outward facing surface of the bead core thereby forming a first rubber body which is bonded to the bead core. Subsequently, the bead core and the first rubber body bonded thereto are turned upside-down. Then, a second continuous ribbon-shaped rubber material is laminated from initially downward but now upward facing surfaces of the bead core and the first rubber body. A disadvantage of said method is that it is cumbersome, error-prone and time consuming to laminate the rubber body from the bead core.

An object of the present disclosure is to provide an alternative method and apparatus for forming a tire bead assembly. It is an object of the present invention to alleviate or solve at least one of the disadvantages mentioned above. In particular, the invention aims at providing a method and/or an apparatus for manufacturing a tire bead core assembly, wherein at least one of the disadvantages mentioned above is counteracted or advantages there above are obtained. In embodiments the invention aims at providing a method of and/or an apparatus which is relatively simple and/or relatively sure. In embodiments the present invention aims at providing a method, wherein the cutting surfaces of the bead filler intermediate are relatively tightly lined out after the attachment of the intermediate to the bead core.

In a first aspect a method of the present disclosure provides for a method of manufacturing a tire bead core assembly having a bead core and a bead filler, the method comprising the steps of: placing the bead core in a compression mould; placing a bead filler intermediate in the compression mould; and pressing the bead filler intermediate onto the bead core using the compression mould.

By using the compression mould to press the bead filler intermediate onto the bead core, after the intermediate and the bead core have been placed into the mould, the bead filler intermediate can be attached to the bead core in one simple action, e.g. closing the compression mould in a direction substantially parallel to the bead core's axis. Therefore, executing a plurality of actions at least partly simultaneously becomes redundant, and a relatively simple and relatively error-proof method is provided.

By using the compression mould to press the bead filler intermediate onto the bead core—which both have been placed into the mould—it is made possible to exert a pressure substantially evenly distributed over the substantially full length of the intermediate and/or to exert a pressure substantially evenly distributed over the substantially complete periphery of the bead core. Therefore, the method may facilitate creating a relatively uniform attachment of the bead filler to the bead core.

In an aspect of the invention, the bead filler intermediate, which preferably is an elongated element made of material from which a bead filler is to be formed, such as a rubber compound, can for instance be made or formed by extrusion, rolling, pressing, calendering, injection extrusion moulding and/or any other suitable method.

Preferably, the bead filler intermediate is pressed onto the bead core when said intermediate substantially has a temperature below a melting point or below a lower value of a melting range of a reinforcing resin, such as but not limited to a rubber reinforcing resin, comprised in the material of the intermediate, such as but not limited to a rubber compound. By pressing a relatively cool intermediate onto the bead core, it can be counteracted that a bead filler, into which the intermediate has been transformed, returns at least partly to an initial shape of said intermediate. Moreover, this may prevent undesired changes in for example material properties, alignment of mono- and/or polymers in the material, stress within the element, flow or creep of the material and the like.

In embodiments, the temperature of the bead filler intermediate is kept at or below a predefined temperature, for instance at or below a temperature of 95° C., 90° C., 85° C., 80° C., 75° C., 72° C., 70° C., 68° C., 65° C. or 60° C., when the bead filler intermediate is pressed onto the bead core.

Preferably, the bead filler intermediate is formed or made outside the compression mould. This is, the intermediate is not formed or manufactured inside the compression mould, but a preformed bead filler intermediate will be placed into the mould. By using a preformed bead filler intermediate, bead filler intermediates may be manufactured at a different site and/or at a different time than the bead core assembly. Consequently, a manufacturing process may be organized relatively efficiently. Besides, by manufacturing the bead filler intermediate outside the compression mould, cooling down the bead filler intermediate inside the compression mould and/or cooling down the compression mould itself can be counteracted. This can be very advantageously, since a bead filler intermediate can be substantially made at a relatively high temperature, such as a temperature corresponding to or above a melting point or a lower value of a melting range of a reinforcing resin, such as but not limited to a rubber reinforcing resin, comprised in a material to be comprised in said bead filler intermediate, such as for instance a temperature of or above 90° C. or 95° C. As a result, a cycle time of manufacturing a tire bead core assembly with the aid of a compression mould can be relatively short. Additionally or alternatively, the compression mould can be of relatively simple design, since it can lack a cooler.

Preferably, the bead filler intermediate is only placed into the compression mould after it has been formed, more preferably after said intermediate has reached a predefined temperature, such as a temperature of or below 95° C., 90° C., 85° C., 80° C., 75° C., 72° C., 70° C., 68° C., 65° C. or 60° C. or a temperature of or below a melting point or a lower value of a melting range of reinforcing resin, such as but not limited to a rubber reinforcing resin, comprised in said bead filler intermediate.

In embodiments, a preformed bead filler intermediate is cooled down after it has been formed, preferably outside the compression mould. For instance, the bead filler intermediate can be cooled down to or below a melting point or to or below a lower value of a melting range of a reinforcing resin, such as but not limited to a rubber reinforcing resin, comprised in the material of the intermediate and/or to or below a predefined temperature, such as a temperature of 95° C., 90° C., 85° C., 80° C., 75° C., 72° C., 70° C., 68° C., 65° C. or 60° C.

It is noted that cooling down has to be understood as at least including but not necessarily limited to actively cooling down. For example, the bead filler intermediate can at least partly be cooled down by providing, for instance blowing, relatively cool air to the intermediate and/or by means of a cooling drum and/or other cooling means. Additionally or alternatively, the bead filler intermediate may at least partly be cooled down passively, for instance by temporarily storing said intermediate at a relatively low temperature such as at a room temperature.

In a further aspect of the present invention, the bead filler intermediate is substantially statically pressed onto the bead core.

In this description statically pressing is at least to be understood as but not limited to meaning that the orientation of corresponding pressing surfaces (e.g. compressing surfaces and/or supporting surfaces) is substantially static during the pressing, at least relative to the bead filler intermediate, i.e. the pressing surfaces are substantially not rotating relative to each other and/or to the bead filler intermediate during at least most and preferably substantially all of the pressing. For example, during pressing, two corresponding pressing surfaces move relative to each other substantially only in a pressing direction, e.g. a direction towards each other.

By transforming a cross section of the bead filler intermediate into a differently shaped cross section of the bead filler, it is made possible to use a bead filler intermediate with a differently shaped cross section than the desired cross section of the bead filler in the eventually manufactured bead core assembly. If, for instance, a bead filler with a triangular cross section is desired, it may be possible to use a bead filler intermediate with a different shaped cross section. For example, an intermediate with a circular or oval shaped cross section can be used, which may be easier and surer to produce, for instance because such an intermediate has no sharp longitudinal edges as an intermediate with a triangular cross section may have.

Further, transforming the cross section may facilitate and/or alleviate the need of properly aligning cutting surfaces of the bead filler intermediate prior to the attachment of the intermediate to the bead core, because initially different and/or shifted cross section can be transformed into an eventually similar cross section.

By substantially concentrically placing the bead filler intermediate relative to the bead core prior to pressing the bead filler intermediate onto the bead core, filler material of the bead filler intermediate can be distributed substantially evenly about the periphery of the beat core prior to attachment. Therefore, it can be counteracted that filler material locally accumulates. For example, even if the initially used intermediate is a little shorter or longer than intended, the intermediate can be placed substantially concentric with respect to the bead core, e.g. by placing said intermediate a little bit more inwardly or outwardly, respectively. As a consequence, the method may depend less on the length of the intermediate, and may thereby provide for a less error-prone and/or easier, more convenient method of manufacturing a bead core assembly.

By providing a substantially ring shaped bead filler, placing said intermediate substantially concentrically around the bead core may be easy.

By providing the bead filler intermediate with a substantially circular cross section, it may be easier to align its proximal end and its distal end. Therefore, accumulation of filler material in certain areas of the bead filler may be counteracted. For example, even if the intermediate placed in the mould is twisted to some extent, the circular cutting surfaces at its proximal end and the distal end may properly fit. Moreover, a bead filler intermediate with a substantially circular cross section may facilitate such twisting, for instance when said twisting is desired to avoid excessive material stresses in the intermediate which otherwise may e.g. lead to highly undesired locally tilting of the intermediate with respect to the plane transverse to the axis of the bead core.

By attaching, e.g. welding, a first end to a second end of an initially linear intermediate, a ring shaped intermediate may be provided, prior to pressing the intermediate onto the bead core. The ring shaped intermediate may facilitate concentric placement of the intermediate. It is noted that cutting surfaces at the first end en second end may be attached being twisted with respect to each other.

The invention also relates to a tire bead core assembly forming apparatus, a tire bead core assembly, a tire, a bead filler intermediate and a use of a compression mould.

Advantageous embodiments according to the invention are described in the appended claims.

By way of non-limiting example only, embodiments of the present invention will now be described with reference to the accompanying figures in which:

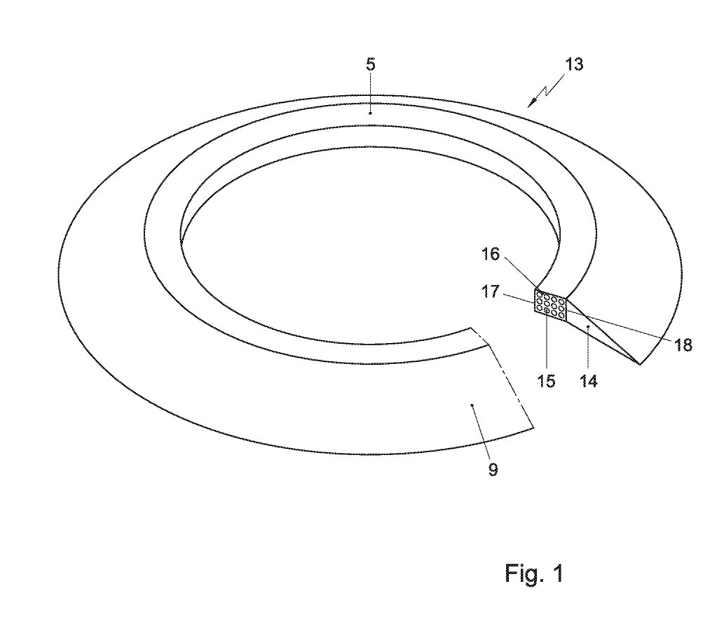

FIG. 1 shows a schematic perspective, partly cutaway view of a tire bead core assembly;

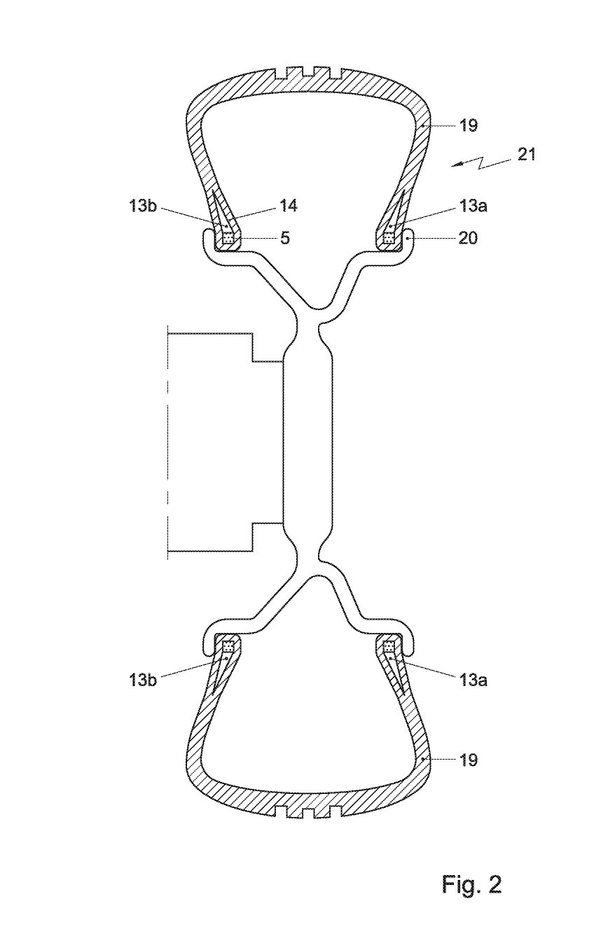

FIG. 2 shows a schematic cross sectional view of a tire, comprising the bead core assembly of FIG. 1a;

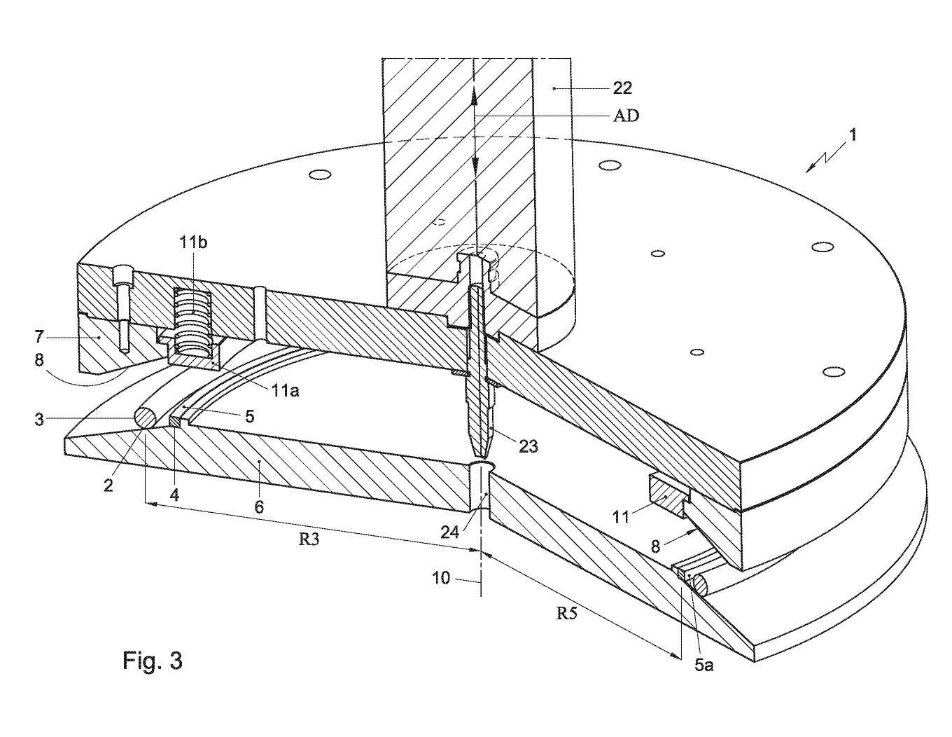

FIG. 3 shows a schematic perspective, partly cutaway view of a tire bead core assembly forming apparatus according to the invention in a first position, and shows further a bead core and a bead filler intermediate according to the invention;

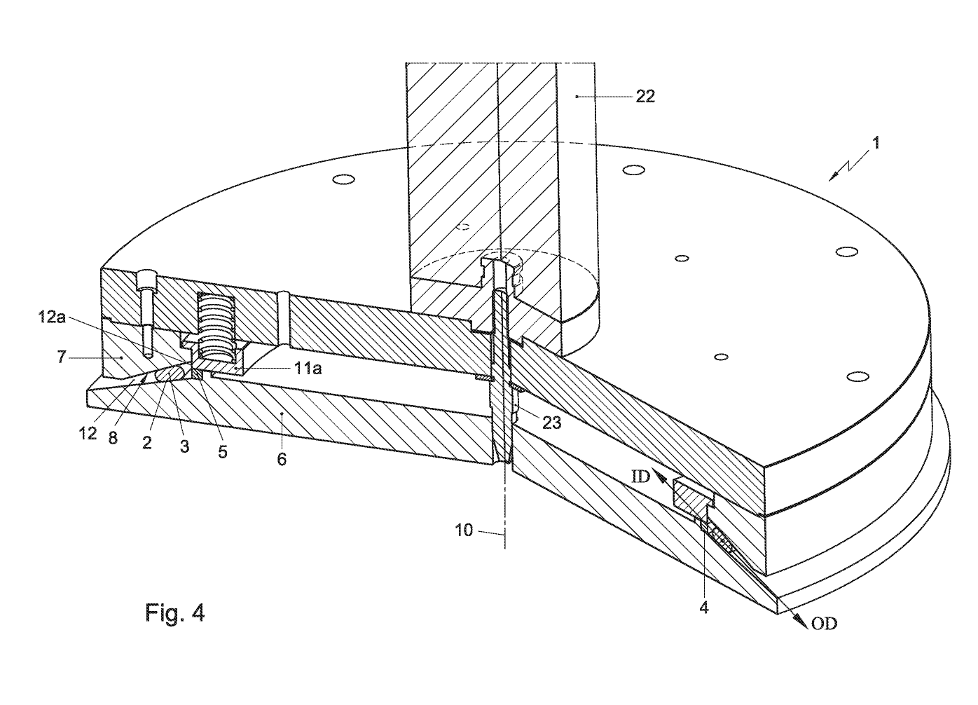

FIG. 4 shows a schematic perspective, partly cutaway view of the apparatus, the bead core and the intermediate of FIG. 3 in a second position; and

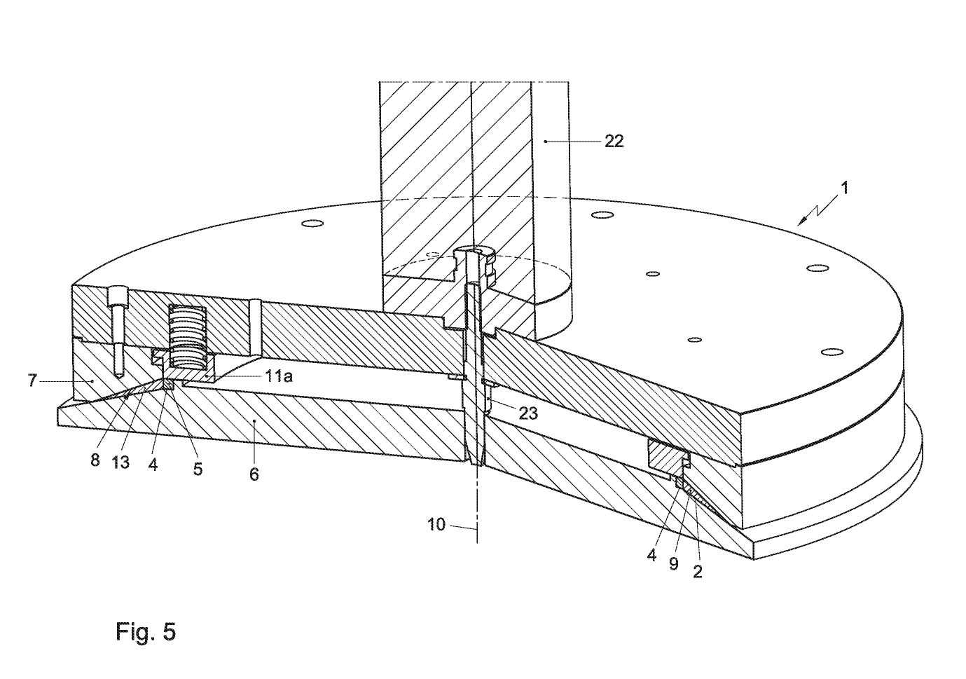

FIG. 5 shows a schematic perspective, partly cutaway view of the apparatus of FIG. 3 in a third position, and a bead core assembly according to the invention.

The embodiments disclosed herein are shown as examples only and should by no means be understood as limiting the scope of the claimed invention in any way. In this description the same or similar elements have the same or similar reference signs.

In this description a bead core assembly has to be understood as at least including but not necessarily limited to a configuration of at least a bead filler and a bead core, the bead filler preferably attached to the bead core. A bead filler can largely be formed from an elastomeric or rubber material and can be vulcanised, if desired. A bead filler intermediate is to be understood as including at least but not limited to an elongated element made of material from which a bead filler is to be formed, which element can have a substantially constant cross section over its length direction, and can for example be formed by extrusion, rolling, pressing, calendering, injection extrusion moulding or any other suitable method. The element can have any suitable cross section, such as including but not limited to circular, oval, oblong, rectangular, triangular or polygonal. A bead core is at least to be understood as including but not limited to a substantially circular element, e.g. made of a relatively rigid material such as metal, to be enclosed in a tire and to be placed on, at least adjacent to a rim, which core is designed to aid in maintaining a proper alignment and abutment of the tire to the rim. The core can for example comprise a solid element, for example coated, or one or a number of, e.g. coated, wire elements, which can be embedded in a matrix material such as but not limited to an elastomeric or rubber material. It is noted that the bead core does not need to include a matrix material, and may additionally or alternatively have a coating of lubricant and/or fatty acid disposed about the bead core. The bead core may for example be a so called cable bead, for instance being a bead core wound from wire, preferably wire having a rubber or elastomeric coating for facilitating adhesion between the cable bead and bead filler material and between the cable bead and material of other parts of the tire. Bead cores and bead fillers are known in the art, as are materials that can be used for forming the same.

In general terms the present invention can be understood as directed to a system for forming a bead core assembly, for example as a step in the process of manufacturing a tire, for example a vehicle tire. In the present invention a bead filler can be formed from a bead filler intermediate, by pressing the bead filler intermediate.

In this description words like substantially or about should be understood as meaning that a slight variation on or deviation from an orientation or dimension or other product or method related feature is possible within the scope, at least such as would be understood by the skilled person. Such variation or deviation can for example be between 0 and 20%, more specifically between 0 and 15%, such as for example between 0 and 10% of the originally disclosed value or orientation or the like. By way of example this should be understood as meaning that for a direction an angular variation would be allowable, such as when directions are defined as being substantially perpendicular, at least deviations thereof of less than 18, 14 or 9 degrees would be within the scope, whereas for parallel directions, including an angle of 180 degrees, at least similar variations would be within the scope.

FIG. 1 shows a schematic perspective, partly cutaway view of a tire bead core assembly 13. In the shown embodiment, the bead core assembly includes a configuration of a bead core 5 and a bead filler 9 attached thereto. The bead filler 9 is a ring shaped element and has a substantially constant, substantially triangular cross section 14. Alternatively, the bead filler may have another cross section, such as a rounded off rectangular cross section. Preferably, the bead filler is made from an elastomeric or rubber material. More preferably, the bead filler is made by pressing a bead filler intermediate made from a transformable elastomeric or rubber material into the form of the eventual bead filler.

In the embodiment shown, the bead core 5 is a substantially ring shaped element comprising a number of substantially parallel wire elements 15, and/or one or a number of spirally wound wire elements. The wire elements are preferably made of a high tensile filamentary material such as metal, for example steel, or high performance synthetic material, for example Nylon or Aramid. The wire elements 15 can be embedded in an elastomeric matrix material 16, such as a rubber material. Further, the bead core 5 has a substantially constant, substantially rectangular cross section 17. However, the bead core may have another cross section, e.g. a hexagonal, round or triangular cross section.

In this embodiment, the bead filler 9 is formed by transforming a bead filler intermediate into said bead filler during manufacture of the tire bead core assembly. The transforming bead filler intermediate can be pressed onto an outer surface 18 of the bead core 5, in the course of which a bond can be formed between the bead filler 9 being formed and the bead core 5. Preferably, the forming of the bond comprises fusion bonding, more preferably pressure fusion. Therefore, the material of the outer surface 18 of the bead core 5 and the material of the bead filler intermediate are advantageously chosen such that said materials facilitate the pressure fusion. For example, both the material of the outer surface 18 and the material of the intermediate are made from and/or comprise an elastomeric and/or rubber material. In an advantageous embodiment, the material of the outer surface 18 and the material of the intermediate are made from and/or comprise the same material, preferably the same elastomeric or rubber material, such as conventional rubber tire materials.

FIG. 2 shows a schematic cross sectional view of a tire 19, comprising the bead core assembly of FIG. 1. The tire 19 is fitted on a wheel rim 20. The bead core assembly may aid in maintaining a proper alignment and abutment of the tire 19 to the rim 20. In the shown embodiment, the tire is a tire assembly 21 comprising two bead core assemblies 13a, 13b. For example, the bead core assembly may be vulcanised, for instance after said bead core assembly is enclosed into the tire assembly 21, the bead core assembly may be at least partly vulcanised together with other parts of the tire assembly 21. Alternatively or additionally, the bead core assembly 13 may be, at least partly, vulcanised prior to joining it with other parts of the tire assembly 21.

FIG. 3 shows a schematic perspective, partly cutaway view of a tire bead core assembly forming apparatus 1 according to the invention in a first position. The apparatus 1 may be suitable for forming a bead core assembly 13, e.g. such as shown in FIG. 1, out of at least a bead core 5 and a bead filler intermediate 3. The apparatus 1 comprises a bead core support surface 4 for receiving and supporting a bead core 5. The bead core support surface 4 can be substantially annular. In embodiments the bead core support surface 4 can be substantially rotationally symmetrical. The apparatus 1 further comprises a bead filler intermediate support surface 2 for receiving and supporting a bead filler intermediate 3. The bead filler intermediate support surface 2 can be substantially annular. In embodiments the bead filler intermediate support surface 2 can be substantially rotationally symmetrical. The bead filler intermediate support surface 2 is located radially outward with respect to the bead core support surface 4. Both surfaces 2, 4 are shown as substantially concentric with respect to each other, sharing a common central axis 10. In the embodiment shown the bead filler intermediate support surface 2 is a part of a surface of a truncated cone. However, the bead filler intermediate support surface 2 may be provided alternatively, for instance as a substantially flat surface or part thereof. For example, said bead filler intermediate support surface 2 may be provided as a part of one flat surface which may also include the bead core support surface 4. Alternatively, the bead filler intermediate support surface 2 and the bead core support surface 4 may, for instance, both be a substantially flat surface or part thereof, wherein both flat surfaces can be offset in the axial direction AD, i.e. in a direction substantially parallel to the central axis 10, with respect to each other.

In this embodiment, said support surfaces 2, 4 are both an integrated part of a base element 6, here formed as a base plate 6.

The apparatus 1 further comprises a compressing element 7 having a compressing surface 8 for exerting a pressure to an object, e.g. a bead filler intermediate 3, located between the compressing surface 8 and the bead filler intermediate support surface 2. The compressing surface 8 can be substantially annular. In embodiments the compressing surface 8 can be substantially rotationally symmetrical. The compressing surface 8 and the bead filler intermediate support surface 2 can be conical surfaces, e.g. having different slopes relative to each other, and/or both surfaces can be located offset from each other. In embodiments the compressing surface 8 can be substantially concentric with respect to the bead filler intermediate support surface 2 and/or the bead core support surface 4, and may share the central axis 10 with at least one of the surfaces 2, 4.

In the shown embodiment, pressing means 22 are provided for moving the compression element 7 relatively to the bead filler intermediate support surface 2, the bead core support surface 4 and/or the base element 6, preferably in the axial direction AD. Although the pressing means 22 are in the shown embodiment connected to the compressing element 7, pressing means may alternatively or additionally be provided at other parts, for instance, at the base plate 6.

The pressing means may be or comprise a statically pressing means, e.g. a linear actuator, for statically pressing. It is noted that in this context statically pressing is at least to be understood as but not limited to meaning that the orientation of corresponding pressing surfaces (e.g. compressing surfaces and/or supporting surfaces) relative to each other is substantially static during the pressing, other than in the direction of pressing. For example, during pressing, two corresponding pressing surfaces move relative to each other substantially only in a linear direction towards each other.

It is noted that the apparatus may comprise opening means, for example, opening means being integrated with the pressing means 22.

Further, the apparatus 1 may comprise guiding means and/or centering means for guiding and/or centering parts movable relatively to each other, such as the compressing element 7 which is movable relatively to the base element 6. Although in the shown embodiment the guiding and centering means is formed by a centrally located tapered centre pin 23 and a corresponding centre hole 24, other guiding means and/or centering means may be provided additionally or alternatively, for instance one or a number of off centre guiding means.

In the embodiment shown, the mould 1 further comprises a bead core clamping element 11, having a clamping ring 11a resiliently attached to the compression element 7, by a number of springs 11b comprised in the compression element 7, biased in a direction towards the opposite surface part of the bead core support surface 4. Alternatively, other means, such as magnets and/or actively controlled clamping means, such as clamps may be provided, preferably substantially evenly distributed about the periphery of the compression element 7, and/or the clamping ring 11a may comprise a resilient material. These clamping means can hold the core in place during closure and pressing.

It is noted that the tire bead core assembly forming apparatus according to an aspect of the invention does not need to comprise clamping means and/or a bead core clamping element.

The apparatus 1 can be implemented as a compression mould 1, suitable for use in a method of manufacturing the tire bead core assembly 13 shown in FIG. 1.

FIG. 3-5 show schematic views of subsequent positions of the apparatus 1 during manufacturing of the bead core assembly. During the manufacturing, the bead filler intermediate is pressed onto the bead core, which is shown in FIGS. 4 and 5.

During the manufacturing of the bead core assembly, the bead core 5 and the bead filler intermediate 3 may be placed in the compression mould 1 on the bead core support surface 4 and the bead filler intermediate support surface 2, respectively. The bead core 5 and the bead filler intermediate 3 may be placed into the mould at least partly simultaneously, or one after the other.

As can be best seen in FIG. 3, the inner radius R3 of the placed bead filler intermediate 3 is larger than the outer radius R5 of the placed bead core 5 to such an extent that the substantially concentrically placed bead filler intermediate 3 and bead core 5 are, prior to pressing, spaced apart in the compression mould 1 relative to each other. This means that in the first position, before the mould 1 starts pressing the bead filler intermediate 3, said intermediate is not touching the placed bead core 5. This may be advantageous, for instance because the filler material of the intermediate 3 may be pushed into both the substantially radially inward direction ID and the substantially radially outward direction OD, as best can be seen in FIG. 4. Therefore, pressing may take relatively little time and/or energy, compared to pressing all or most of the filler material into substantially the same direction, e.g. the inward direction ID. Alternatively the bead filler intermediate can be touching the core or can be spaced further apart from the core.

In the shown embodiment, the bead filler intermediate 3 being placed into the mould, here having a circular cross section, is ring shaped and has an outer radius R3. The ring shape can, for instance, be created by attaching two ends of an initially linear intermediate.

Alternatively, a substantially linear intermediate may be placed substantially annularly on the bead filler intermediate support surface 2. The proximal end and the distal end of said initially substantially linear intermediate may subsequently be attached to each other. Alternatively or additionally, one or both of said ends may be kept in place otherwise. For example, at least one end may be kept in place by loosely gluing a portion of the intermediate near said end onto the intermediate support surface 2 or by temporarily mounting said portion relative to said surface, for instance with the use of a clamping means, a clip, or the like, which is preferably provided in the mould, e.g. as a part of the compressing element 7 or base part 6. For example, a pressing finger resiliently attached to said element 7, may initially protrude from the compressing surface 8 in e.g. a downward direction, and may eventually be pushed upwardly relative to the compressing surface 8, preferably in such a way that a bottom surface of said finger in an end position is substantially flush with the compressing surface 8.

As noted above, FIG. 3 shows a view of the tire bead core assembly forming apparatus 1 in a first position. In the first position the bead core 5 and the bead filler intermediate 3 are both located in the compression mould 1 and supported by the bead core support surface 4 and the bead filler intermediate support surface 2, respectively.

FIG. 4 shows a schematic perspective, partly cutaway view of the apparatus 1, the bead core 5 and the intermediate 3 of FIG. 3 in a second position. In the second position, the compressing element 7 of the closing mould 1 is being moved relatively towards the base element 6. As can be clearly seen in FIG. 4, the intermediate 3 is squashed between the intermediate support surface 2 and the compressing surface 8.

As best can be seen in FIG. 4, in the shown embodiment the clamping ring 11a clamps the bead core at least partly during the closing of the mount. During the closing, the clamping ring 11a may then, e.g. together with compression surface 8, define an inner border 12a of a compressible cavity 12 in which the bead filler 9 can be formed.

FIG. 5 shows a schematic perspective, partly cutaway view of the apparatus 1 of FIG. 3 in a third position, and a bead core assembly 13 according to the invention. In the third position, the mould 1 is substantially completely closed. In the shown embodiment, the yet further squashed intermediate has been pressed onto the bead core 5 and has been transformed into a bead filler 9, attached to said bead core 5. In the embodiment shown, the filler material is pressure fused to the bead core 5, preferably at least to a peripheral outer surface 5a of the bead core.

During the pressing of the bead filler intermediate onto the bead core, the bead filler intermediate is preferably pressed simultaneously over its substantially full peripheral length against the bead core, more preferably by exertion of a pressure substantially evenly distributed over the substantially full peripheral length of the intermediate 3 and/or by exerting a pressure substantially evenly distributed over the substantially peripheral full length of the bead core 5. Therefore, for example, a relatively evenly distributed bonding between bead core and bead filler may be obtained. Such pressing can be understood as substantially static.

In embodiments the pressing may take place in heated conditions, for instance to facilitate pressure fusion, e.g. of elastomeric or rubber materials. Therefore, for instance, an even improved adhesion between bead core and bead filler may be obtained.

Further, manufacturing the tire bead core assembly 13 may comprise vulcanising. For example, after pressing the bead core assembly 13 may, at least partly, be vulcanised, for instance in the mould 1. Alternatively or additionally, the bead core assembly 13 may, at least partly, be vulcanised with other means, for instance after said assembly 13 has been removed from the mould. Alternatively or additionally, the bead core assembly 13 may, at least partly, be vulcanised after said assembly 13 has been enclosed in a tire 19.

In preferred embodiments the bead filler intermediate material is compressed such that substantially all gas such as air is forced out of the material and out of the mould, such that substantially no gas is entrapped in the bead core assembly before vulcanisation thereof. This prevents blowing bubbles in the bead core assembly or surrounding material during vulcanisation of the bead core assembly and/or of a tire.

The invention is not restricted to the embodiments described above. It will be understood that many variants are possible.

For example, the compressing surface 8 and/or the bead filler intermediate support surface 2 can be substantially convex or concave, e.g. for manufacturing a tire bead core assembly including a bead filler having a non-triangular cross section configuration.

It is noted that neither the bead core support surface 4, nor the bead filler intermediate support surface 2, needs to be an even surface. The bead core support surface and/or the bead filler intermediate support surface may for instance comprise one or a number of twists, dips, grooves, dimples, ridges, textures, protrusions and/or inscriptions or similar surface variations or deviations, which may facilitate manufacture of varying bead core assemblies. For example, dimples in the bead core support surface may lead to raised dots on the bead filler, which dots may e.g. be used as distinguishing marks. Similarly texts or other codes can be provided by pressing them into or onto a bead filler or bead core surface.

In alternative embodiments the mould can be formed such that the bead filler intermediate material can be forced partly along at least part of outer surface areas of the bead core, such as an upper or lower surface thereof, such that the material is forced against the peripheral surface and along said one or more further surfaces. In embodiments the material can be forced into the bead core, especially if the bead core is a cable bead core.

Furthermore, the bead core and intermediate can be placed in the mould in any suitable order, including simultaneously.

These and other embodiments will be apparent to the person skilled in the art and are considered to lie within the scope of the invention as formulated by the following claims.

1. Method of manufacturing a tire bead core assembly having a bead core and a bead filler, the method comprising the steps of:
placing the bead core in a compression mould;
placing a bead filler intermediate in the compression mould; and
pressing the bead filler intermediate onto the bead core using the compression mould.

2. Method according to claim 1, wherein the step of pressing the bead filler intermediate onto the bead core comprises:
transforming the bead filler intermediate into a bead filler.

3. Method according to claim 2, wherein a cross section of the bead filler intermediate transforms into a cross section of the bead filler, the cross sections differing in shape and/or surface area.

4. Method according to claim 1, wherein the bead filler intermediate and the bead core are placed substantially concentrically relative to each other prior to pressing the bead filler intermediate onto the bead core.

5. Method according to claim 4, wherein the placed bead filler intermediate and the placed bead core are substantially ring shaped, the diameter of the placed bead filler intermediate being larger than the diameter of the placed bead core to such an extent that the substantially concentrically placed bead filler intermediate and bead core are spaced apart in the compression mould relative to each other.

6. Method according to claim 1, wherein the bead filler intermediate has a substantially circular cross section.

7. Method according to claim 1, wherein the bead filler intermediate comprises an elongated element having a first end and a second end, and wherein the first end is attached, preferably by welding, to the second end prior to pressing the bead filler intermediate onto the bead core, preferably also prior to placing of the bead filler intermediate in the compression mould.

8. Method of manufacturing a tire bead core assembly having a bead core and a bead filler, the method comprising the steps of:
providing the bead core;
providing a bead filler intermediate;
placing the bead filler intermediate and the bead core substantially concentrically with respect to each other; and
attaching the bead filler intermediate onto the bead.

9. Method according to claim 8, wherein the step of attaching comprises:
pressing the bead filler intermediate simultaneously over its substantially full length against the bead core, preferably by exerting a pressure substantially evenly distributed over the substantially full length of the intermediate and/or by exerting a pressure substantially evenly distributed over the substantially full length of the bead core.

10. Tire bead core assembly forming apparatus comprising:
a substantially annular bead core support surface for receiving and supporting a bead core;
a substantially annular bead filler intermediate support surface for receiving and supporting a bead filler intermediate, the bead filler intermediate support surface being located radially outward with respect to the bead core support surface, both surfaces being substantially concentric with respect to each other; and
a compressing element having a compressing surface for exerting a pressure to the bead filler intermediate supported on the bead filler intermediate support surface.

11. Tire bead core assembly forming apparatus according to claim 10, wherein the compressing surface is arranged for cooperation with the bead filler intermediate support surface, said surfaces forming a compressing mould for transforming the bead filler intermediate into a bead filler and for attachment of the transforming intermediate to the bead core by pressing said intermediate against said bead core.

12. Tire bead core assembly forming apparatus according to claim 10, further comprising an actuator for moving the compressing surface and the bead filler intermediate support surface relative to each other, preferably in a direction substantially parallel with axis of the substantially annular bead core support surface.

13. Tire bead core assembly, comprising:
a bead core; and
a thereto attached bead filler, formed from a bead filler intermediate pressed simultaneously over its substantially full length against the bead core.

14. Tire comprising at least one tire bead core assembly according to claim 13.

15. Bead filler intermediate, being substantially annular and having a substantially circular cross section.

16. Use of a compression mould in manufacturing and/or assembling a tire bead core assembly having a bead core and a bead filler.

17. The tire bead core assembly of claim 13, which is manufactured by a method comprising:
placing the bead core in a compression mould;
placing the bead filler intermediate in the compression mould; and
pressing the bead filler intermediate onto the bead core using the compression mould.

18. The tire bead core assembly of claim 13, which is manufactured using an apparatus comprising:
a substantially annular bead core support surface for receiving and supporting a bead core;
a substantially annular bead filler intermediate support surface for receiving and supporting a bead filler intermediate, the bead filler intermediate support surface being located radially outward with respect to the bead core support surface, both surfaces being substantially concentric with respect to each other; and
a compressing element having a compressing surface for exerting a pressure to the bead filler intermediate supported on the bead filler intermediate support surface.

19. The tire of claim 14, which is a pneumatic tire.

20. A tire, comprising at least one tire bead core assembly, wherein the bead core assembly is manufactured using the method of claim 1 or using an apparatus comprising:
a substantially annular bead core support surface for receiving and supporting a bead core;
a substantially annular bead filler intermediate support surface for receiving and supporting a bead filler intermediate, the bead filler intermediate support surface being located radially outward with respect to the bead core support surface, both surfaces being substantially concentric with respect to each other; and
a compressing element having a compressing surface for exerting a pressure to the bead filler intermediate supported on the bead filler intermediate support surface.
